(19) United States
(12) Patent Application Publication
(10) Pub. No.: US 2023/0316193 A1
(43) Pub. Date: Oct. 5, 2023

(54) ESTIMATING THE EFFECT OF RISKS ON A TECHNICAL SYSTEM

(71) Applicant: Risilience Limited, Cambridge, Cambridgeshire (GB)

(72) Inventors: Andrew Coburn, Cambridge, Cambridgeshire (GB); Andrew Skelton, Cambridge Cambridgeshire (GB); Simon Ruffle, Cambridge, Cambridgeshire (GB)

(21) Appl. No.: 18/011,086

(22) PCT Filed: Jun. 17, 2021
(86) PCT No.: PCT/IB2021/055370

§ 371 Date: Dec. 16, 2022

Related U.S. Application Data
(60) Provisional application No. 63/042,592, filed on Jun. 23, 2020.

(30) Foreign Application Priority Data
Jun. 18, 2020 (GB) 2009309.2

(51) Int. Cl. G06Q 10/0635

(52) U.S. Cl. CPC G06Q 10/0635

(57) ABSTRACT

There is disclosed a computer-implemented method for facilitating estimation of the effect on a technical system of at least one type of risk to the system, each type of risk having a characteristic defined at least partly by a parameter, and the method comprising: for each type of risk: selecting a plurality of values of the parameter that defines the characteristic of the type of risk; and for each of the selected parameter values: generating an estimate of a numerical effect on at least one state, resource requirement or output of the technical system for the present type of risk having the selected characteristic parameter value; generating an estimate of a likelihood of occurrence of said numerical effect; and processing the pairs of estimated numerical effect and estimated likelihood of occurrence to generate a mathematical function having an input corresponding to a parameter of the type of risk and an output corresponding to an estimated numerical effect and a corresponding estimated likelihood of occurrence, whereby an estimate of the expected numerical effect on at least one state, resource requirement or output of the technical system and an estimate of the likelihood of occurrence of the effect can be provided efficiently for a full range of parameters of all the types of risk.

### FIELD OF THE INVENTION

The present invention relates to computer-implemented methods of estimating the effect on a technical system of at least one type of risk to the system, and computer systems programmed to carry out such methods. The present invention has particular applicability to complex technical systems.

### BACKGROUND OF THE INVENTION

Typically, as the complexity of or reliance on a technical system grows, there is an increased need to assess the system to understand and plan for adverse operating conditions or unexpected events. In a typical assessment, specific potential risks to the system may be identified, and their likelihood and potential impact assessed. For example, an assessment of a computerised system may identify cyber-attacks and power outages as potential risks, and the potential impact of each risk may be determined. In some cases, the likelihood of an event occurring may also be determined. Both the likelihood and impact of potential risks may to a greater or lesser extent depend on the inherent properties or design of the system; for example, cyber-attacks will be relatively low likelihood events for a computer system which does not have connections to the Internet, but may be relatively high likelihood events if the system is connected.

In a traditional risk assessment study, impacts and likelihoods are classified using subjective, discrete values (such as ‘minor’ and ‘critical’ impacts, and ‘remote’ and ‘very likely’ probabilities). This approach is traditionally seen as having the advantage of allowing easy visualisation of different, unrelated types of risk, although the subjectivity of the impact and likelihood values typically requires human input in the classification process.

Mitigation strategies may be considered which address one or more of the identified risks. Another set of subjective judgements is then required to identify how each risk is expected to change if a particular mitigation strategy or set of strategies are applied. For example, a risk may be considered to be only a possible risk rather than likely risk if a mitigation strategy is applied, or to have only a major impact rather than a critical impact if the strategy is applied. Decisions may then be taken regarding the management or redesign of the technical systems based on the sets of impact vs probability information mentioned above.

The orthodox approach to risk management described above has a number of shortcomings. There is a need for a new approach which allows an objective, technical and computerised/automated assessment of risks to a technical system, and which facilitates the objective assessment and (optionally automated) selection of mitigation strategies for improving the resilience and performance of the system. There is in some cases a need for a computerised system that is able to provide a real-time response to dynamically evolving and/or automatically evaluated risks to a technical system.

The present invention aims to address problems in the art mentioned above.

### SUMMARY OF THE INVENTION

According to a first aspect of the present invention, there is provided a computer-implemented method for facilitating estimation of the effect on a technical system of at least one type of risk to the system, each type of risk having a characteristic defined at least partly by a parameter, and the method comprising: for each type of risk: selecting (or providing, or receiving) a plurality of values of the parameter that defines the characteristic of the type of risk; and for each of the selected parameter values: (in some cases, optionally) generating an estimate of a numerical effect on at least one state, resource requirement or output of the technical system for the present type of risk having the selected characteristic parameter value; and (optionally) processing the estimates of numerical effect to generate a mathematical function having an input corresponding to a parameter of the type of risk and an output corresponding to an estimated numerical effect, whereby optionally an estimate of the expected numerical effect on at least one state, resource requirement or output of the technical system can be provided relatively efficiently for a full range of parameters of all the types of risk.

A ‘technical system’ preferably connotes a system including or relating to one or more technical components, said components including but not limited to at least one of a computer, any other type of electronic device, an electrical device, electrical, gas, water or other type of technical infrastructure, a mechanical apparatus, and a vehicle or fleet of vehicles. A state, resource requirement or output of the technical system preferably connotes an objective, measurable or determinable property or requirement of the system, such as a physical quantity or other quantifiable property of the system, for example a number of units or amount of a product manufactured or otherwise output; a power drain or power output of the system; an amount of materials or other measurable quantity consumed by, other otherwise required to be input into, the system; a number of functioning elements within the system, and so on. A parameter is essentially any value or other property or quantitative entity allowing the characteristic to be specified or selected in an appropriate fashion. Preferably at least one of the inputs, outputs and internal states of the technical system has a respective range of values corresponding to the normal operation of the system. A risk preferably connotes the occurrence of an input, output or internal state of the technical system outside a range of values as aforesaid. A risk may alternatively or additionally relate to one or more values of at least one of the inputs, outputs and internal states of the technical system having an expected or observed occurrence of less than a predetermined frequency of occurrence.

For example, a particular set of values or threshold for values of a particular input (or output, or internal state, and so on) may be defined as risk states. Alternatively or additionally, a risk state may be defined as the occurrence of an aforesaid set of values or threshold either more than a predetermined number of times in a specific time period (such as a month, year or decade, for example) or with less than a predetermined interval (such as a month, year or decade, for example) between incidents. Other definitions and schemes are of course possible.

Merely determining a numerical effect of a potential risk on the technical system represents a significant improvement over traditional methods of attributing a more subjective qualitative ‘impact’ to potential risks. Furthermore, the mere consideration of different characteristics of a particular type of risk represents an improvement over the traditional methods, allowing a more detailed and comprehensive study of the relevant risk, rather than using a ‘one size fits all’ approach that leads away from a reasonable quantitative analysis of the problem.

The step of generating a general mathematical function based on a select number of calculated estimates (for example fitting a curve to a select number of data points, or similar) allows the processing underlying the estimation of the relevant properties to be greatly simplified. Subsequently estimates can be provided for any appropriate parameter using a relatively efficient process. This can in turn greatly simplify and make more efficient the management of a technical system in the face of potential risks affecting its operation, and increase the resilience of the system overall.

By this process, estimates of impacts of parameterized risks on technical systems can be produced objectively and/or mathematically, ideally allowing subjectivity and the need for human interaction to be removed from relevant parts of the process of estimating the effect of different risks on a technical system. Preferably the selection of parameters is substantially uniformly distributed within the relevant range of expected values of the characteristic, but need not be. The parameters may be discrete or continuous as appropriate, and the method may further comprises generating a locus of points or a continuous line (at least conceptually) corresponding to multiple outputs of the estimated function.

In this and the following aspects of the invention, preferably the technical system is a complex technical system.

In a related aspect of the invention, there is provided a computer-implemented method for facilitating estimation of the effect on a technical system of at least one type of risk to the system, each type of risk having a characteristic defined at least partly by a parameter, and the method comprising: for each type of risk: selecting a plurality of values of the parameter that defines the characteristic of the type of risk; and for each of the selected parameter values: generating an estimate of the likelihood of occurrence of the present type of risk having the selected characteristic parameter value; and processing the estimated likelihood of occurrence to generate a mathematical function having an input corresponding to a parameter of the type of risk and an output corresponding to an estimated likelihood of occurrence, whereby an estimate of the likelihood of occurrence of type of risk in the technical system can be provided relatively efficiently for a full range of parameters of all the types of risk.

Providing a quantitative assessment of the likelihood of occurrence of various risks provides another improvement over traditional methods of risk assessment, let alone in conjunction with the features relating to generating a mathematical function on the basis of select estimations based on a select number of parameters of the relevant risks.

In a further aspect of the invention, combining features of the previous two aspects, there is provided a computer-implemented method for facilitating estimation of the effect on a technical system of at least one type of risk to the system, each type of risk having a characteristic defined at least partly by a parameter, and the method comprising: for each type of risk: selecting a plurality of values of the parameter that defines the characteristic of the type of risk; and for each of the selected parameter values: generating an estimate of a numerical effect on at least one state, resource requirement or output of the technical system for the present type of risk having the selected characteristic parameter value; generating an estimate of a likelihood of occurrence of said numerical effect; and processing the pairs of estimated numerical effect and estimated likelihood of occurrence to generate a mathematical function having an input corresponding to a parameter of the type of risk and an output corresponding to an estimated numerical effect and a corresponding estimated likelihood of occurrence, whereby an estimate of the expected numerical effect on at least one state, resource requirement or output of the technical system and an estimate of the likelihood of occurrence of the effect can be provided efficiently for a full range of parameters of all the types of risk.

This aspect combines both approaches of the previous aspects. There is a clear synergy in estimating both the likely numerical effect on the system and also its likelihood. This allows more sophisticated planning and mitigation actions to be taken, balancing the need to prevent events with a measurably extreme impact with the need to plan for more likely events and circumstances. It will be appreciated that following features relating to the present aspect of the invention (or any subsequent aspects) may equally be applied, where appropriate, to the first and second aspects of the invention also.

By use of the present method, it can be possible to compare, benchmark, and prioritise different types of risks that are qualitatively different, by measuring their output metrics on the technical system in a consistent way. It is possible in particular to estimate the effect on the technical system of combinations of different risks occurring to the system coincidentally or causally, by considering the interaction of the component parts of the technical system in the outputs.

The method preferably further comprises using the generated mathematical function to estimate the effect on the technical system of at least one said type of risk. The method may additionally or alternatively comprise using the generated mathematical function for any technical purpose relating to the technical system, for example to mitigate the effect of the types of risk, or to use insight into the quantitative properties of different types of risk to design or redesign the technical system or any subcomponent thereof.

The method may further comprise receiving at least one input parameter value; processing said at least one input parameter value in accordance with said mathematical function to generate at least one respective output including an estimate of numerical effect on at least one state, resource requirement or output of the technical system and an estimate of the likelihood of occurrence of the effect; and in dependence on said at least one output, carrying out at least one of: (i) modifying a state, property or input of the system, and (ii) modifying an amount of resources provided to or allocated to the system, so as to reduce the expected impact on the system of at least one said type of risk. This can provide an objective, optionally real-time, tool for improving the resilience of a technical system to at least partially predictable types of risk.

Preferably the same state, resource requirement or output of the technical system is used for all types of risk. This allows a direct comparison of the effects of the different and possibly quite diverse types of risk on the technical system. This allows the potential for improving the objectivity and/or automation of any processes for prioritising types of risk or prioritising responses to different types of risk.

The state or output may be an artificial or virtual construct (or otherwise), derived from measurable or otherwise intrinsic properties of the system, created for the purpose of allowing ease of comparison between different risks, for example. The state or output may, for example, be a standard metric of any appropriate type. In one specific example, a financial cost may be assigned to failures or events relating to different parts of the system simply to allow ease of comparison, but this is one example and by no means required. Alternative metrics may for example include a length of downtime, a number of units or products lost or delayed, and a measurement of additional resources required, or any appropriate combination or further derivative thereof. Regardless of the type and technicality of the metric used, the essential effect is a technical one, to improve the technical properties of the system so as to provide more resilience against various classes of risk.

Preferably at least one said characteristic is selected from: a speed of onset, a degree of severity, and a duration of effect. Other characteristics are possible, relating essentially to any property, state or circumstance relating to a particular type of risk which can affect either the numerical effect of the risk on a system, the likelihood of occurrence of the risk, or both.

In one embodiment, at least one said characteristic is further defined at least partly by a second parameter, and the method further comprises selecting at least one value of said second parameter, and generating said estimates based on the selected said at least one value of said second parameter. For example, a risk may be defined by a characteristic corresponding to a severity of the risk, and that severity may be defined by two (or more) independently variable parameters, corresponding for example to a parameter representing a magnitude of effect and a parameter representing a susceptibility of the technical system to that effect.

Alternatively or additionally, each type of risk may have a second (or further) characteristic defined at least partly by a further parameter, and the method further comprises selecting at least one value of said further parameter, and generating said estimates based on the selected said at least one value of said further parameter of said second characteristic. For example, a risk may be defined by a first characteristic of severity of effect and a second characteristic of speed of onset, and so on. The present method has the advantage of being able to accommodate complex definitions and dependencies of different types of risk.

The method may further comprise: defining a target constraint on at least one of a numerical effect on at least one state or output of the technical system and a likelihood of occurrence of the numerical effect; and processing each mathematical function to determine whether at least one output of the function meets the target constraint for a respective at least one input parameter value of the function. The target constraint may be defined by sets of value pairs, a mathematical constraint on either or both of the numerical effect and likelihood of occurrence, or a geometric description of a space within a plane defined by the numerical effect and likelihood of occurrence, and so on.

A constraint on the numerical effect may or may not be independent of the likelihood, and vice versa. The constraint may for example be a requirement that the numerical effect be less than magnitude X, or that the likelihood be less than probability Y, or that the output pairs of numerical effect and likelihood fall below or above a line defined by a relationship of type A x Numerical effect = B x Likelihood + C, in any appropriate vector space. The constraint may for example identify risks that are of concern, and/or risks that are not tolerable.

The target constraint may be defined in terms of a logarithm or power of the value of at least one of the numerical effect and likelihood of occurrence. This can allow a target constraint to be defined as a relatively straightforward relationship (for example, linear) between the appropriately transformed values, and can reduce the impact of outliers. This can also distribute pairs of numerical effect/likelihood of occurrence more evenly throughout the numerical space for ease of processing, identification, grouping and sorting, and so on.

With a target constraint specified, the step of processing each mathematical function preferably comprises determining whether every output of the function, corresponding to every possible input parameter value of the function, meets the target constraint.

The method preferably further comprises accessing at least one model corresponding to each respective type of risk, each model taking the respective parameter as an input and providing at least one of said numerical effect and said likelihood of occurrence as an output. There could be for example two models for each type of risk, separately providing the estimated numerical effect and the estimated likelihood of occurrence, or a single unified model providing both outputs, or some other means for providing either or both the estimated numerical effect and estimated likelihood of occurrence. One value may be produced in dependence on the other, for example, in accordance with a defined mathematical relationship or otherwise.

The method may further comprise receiving data relating to the respective type of risk of at least one said model, processing the received data, and creating or updating the relevant model in dependence on the processing of the received data.

In this case, the received data preferably comprises at least one of: historical data or real-time data indicative of the likelihood of occurrence and/or severity of the respective type of risk; performance data indicative of the performance of a relevant part of the technical system; correlation data indicative of a correlation between the respective type of risk and one or more other types of risk; location correlation data indicative of geographical regions of the technical system having a related vulnerability to the respective risk; component correlation data indicative of components of the technical system having an interrelated vulnerability to the respective risk; and free text containing content indicative of a likelihood and/or severity of the respective type of risk. The method may further include carrying out free text processing to extract relevant data from a free text source.

In one example, the received data comprises time series data representative of a historical or real-time time series that is indicative of the likelihood of occurrence and/or numerical effect of the respective type of risk, and the method further comprises: processing the received data to identify extreme values of the time series that meet a criterion corresponding to an occurrence of the relevant type of risk; and processing the extreme values to generate an estimate of the likelihood that a particular proportion of a particular period of time will meet the criterion, wherein the generated estimate is used at least in part to create or update the model. Traditionally, average trends are calculated and considered in order to estimate future trends. The present features arise from the inventive realisation that more useful estimations of risk can in most cases be derived by considering extreme values of a time series rather than averages.

In this example, processing the received data may further comprise: dividing the received data into data portions corresponding to a respective plurality of time periods; processing each data portion to calculate the proportion of the respective time period that meets the criterion; and processing the calculated proportions to generate an estimation function, the estimation function having as an input a selection of a proportion of a time period, and having an output representing an estimate of the likelihood that the selected proportion of a time period will meet the criterion.

This method may yet further comprise: selecting a plurality of sample values of proportions of a period of time; for each sample value, processing the calculated values to calculate a representative proportion, being a single value representative of substantially all the data portions, of the time period that has values meeting the criterion; processing the calculated representative proportions to estimate proportions of time for the estimation function at the plurality of sample values; and generating the estimation function in dependence on the estimated proportions of time. The representative proportion could be derived using an appropriate type of average, such as mean, median or mode, as appropriate. However, no further averaging of any data is necessarily required, in contrast to more traditional methods of time series analysis. For example, the estimated function may conceivably have the same average value as historical time series, but a much higher or lower incidence of extreme values (and these are typically what are of interest as regards types of risk). For a time series of daily temperatures, for example, the risk of a data centre overheating is only interested in extreme high temperatures, not any yearly average. The method may comprise processing a distribution of extreme values of data.

The method may further comprise selecting at least one mitigation process from a plurality of possible mitigation processes, and re-generating each function as appropriate in dependence on the selected at least one mitigation process. Preferably the at least one said mitigation process is selected in dependence on whether the target constraint is met.

The term ‘mitigation process’ preferably connotes a predefined selection or combination of at least one process step (which may extend to adding, updating, removing or replacing apparatus features of the technical system, for example). Preferably the output or outputs of each model are changed in dependence on the selected mitigation process, for example by simulating the effect of the presence or operation of the individual element or elements of the mitigation process. The application or simulation of a mitigation process can (and likely will) change the estimated likelihood of occurrence and/or numerical effect. In turn, this can affect whether the target constraint is complied with (if applicable). A mitigation process may be appropriate to being applied prior to the occurrence of a relevant type of risk, afterwards, or both.

In more detail, preferably the mitigation process comprises at least one of: adding, replacing or removing at least one component of the technical system; modifying at least one parameter of the technical system; modifying at least one input to the technical system; modifying the type, source or quantity of at least one resource provided to the technical system; reconfiguring the connection between a plurality of components of the technical system; and modifying the operating procedure relating to at least one component of the technical system.

The method may further comprise providing a cost for each possible mitigation process and selecting said at least one mitigation process at least in part in dependence on said cost, and preferably further comprises modifying the technical system in accordance with said selected at least one mitigation process. This can help to optimise the costs and risk reduction benefits of mitigation. The cost may be any appropriate metric (for example a measurement of internal or external resources required for the mitigation process, or a measurement of a state or property of the system when the mitigation process is applied) or artificial construct selected for the purpose of allowing ease of comparison of different mitigation processes.

In the case where risk models are provided, the method may further comprise modifying at least one said model in accordance with said selected at least one mitigation process. The method preferably further comprises modifying a model of the technical system in accordance with the selected mitigation processes (instead of, or as well as, modifying the technical system itself).

In some cases a plurality of types of risk is assessed. In these cases, the estimation of the numerical effect or likelihood of occurrence for one said type of risk may be dependent on the numerical effect or likelihood of occurrence for at least one other said type of risk. Accordingly relationships or correlations between the types of risk may be defined.

The method may further comprise estimating an additional numerical effect representing additional disruption to the technical system due to a combination of types of risk affecting the technical system. This essentially models the effect of multiple risks reinforcing or exacerbating each other when they are present at the same time. That is, the additional numerical effect is in addition to the numerical effect attributed to each type of risk in isolation. For example, an earthquake and a tsunami may have certain effects in isolation, but in combination they can be far more destructive than the sum of the parts (for example consider the nuclear meltdown at Fukushima Daiichi power station).

The method may further comprise providing system model data representative of a model of the technical system, and wherein generating at least one said estimate comprises processing the system model data to determine the quantitative effect of the respective type of risk on the technical system. It will be appreciated that the model data may be generally be updated before, during or after the various process steps as aforesaid, except where inappropriate or not possible.

The method may further comprise receiving scenario data representative of at least one of: at least one risk to apply to the technical system model; at least one configuration of the technical system; at least one setting of the technical system; at least one value of at least one said parameter of a characteristic of at least one said type of risk; and at least one input of the technical system. Preferably the method further comprises (where applicable) processing the scenario data to apply the scenario to at least one of one or more risk models and technical system model, and optionally further comprises carrying out an estimation or simulation to estimate the effect of the scenario on the technical system in terms of at least one of a numerical effect and likelihood of occurrence.

The method, in any aspect and in relation to any appropriate combination of features, may further comprise summing a plurality of estimated numerical effects to calculate a total estimated numerical effect. The method may further comprise, in relation to any appropriate combination of features, processing a plurality of pairs of estimated numerical effects and estimated likelihoods of occurrence to generate a combined or averaged pair of, or a representative set of pairs of (different to the estimated pairs) numerical effect and likelihood of occurrence.

In another aspect of the invention there is provided a method of estimating the effect on a technical system of at least one of a plurality of types of risk to the system, the method comprising: providing (or receiving or generating) risk model data representing a model of each of the plurality of types of risk; selecting at least one of the plurality of types of risk; (in some cases optionally) processing the risk model data to estimate the numerical effect of said at least one selected type of risk on the technical system; receiving risk correlation data representing relationships between different types of risk; and (optionally) for each selected type of risk: (either or both) processing the risk correlation data to identify any related types of risk; and processing the risk model data to estimate the numerical effect of said related types of risk; and (optionally) combining the estimates of numerical effect to determine a combined estimated numerical effect on the technical system due to the selected types of risk.

The method may further comprise calculating an additional numerical effect representing an exacerbation of risks due to their combination. This feature may be substituted with or added to by the aforesaid features relating to additional numerical effect, or any other features as aforesaid, including but not limited to features including mitigation processes, risk characteristics and parameters, risk models, technical system models, and so on.

For example, each type of risk may have a characteristic defined at least partly by a parameter, in which case the method further comprises: selecting at least one value of the parameter that defines the characteristic of each type of risk; and generating said estimates of a numerical effect in accordance with the selected at least one values of the parameters.

In a further aspect of the invention, there is provided a method of reducing the effect on a technical system of at least one type of risk to the system (or otherwise mitigating the effect or taking it into account in a technically useful fashion), the method comprising:

providing (or receiving, or generating) risk model data representing a model of each type of risk; providing (or receiving, or generating) system model data representing a model of the technical system; (in most cases optionally) processing the risk model data and system model data to estimate the numerical effect of said at least one type of risk on the technical system and the likelihood of occurrence of the numerical effect; (typically but not necessarily) processing the estimated numerical effect and likelihood of occurrence to select a mitigation process for reducing at least one of the estimated numerical effect and likelihood of occurrence; and (generally optionally) transmitting instruction data (preferably to the technical system or entity connectable thereto) to cause the implementation of the selected mitigation process.

Preferably the mitigation process comprises at least one of: a reconfiguration of at least one parameter or setting of the technical system; a reprogramming of computer program code in at least one computer system of the technical system; and the addition, removal or replacement of at least one component of the technical system. Other process steps are of course possible as appropriate and/or as described herein in relation to any aspect or embodiment.

In a yet further aspect of the invention, there is provided a method of estimating the effect of a type of risk on a technical system, the method comprising: providing risk model data representing a model of the type of risk; providing system model data representing a model of the technical system; processing the risk model data and system model data to generate an estimate of at the numerical effect of the type of risk on the technical system and a numerical estimate of the likelihood of occurrence of the numerical effect. Preferably the method further comprises using the generated estimate(s) in the management (such as monitoring, configuration, or prediction) of the technical system. The method may equally apply to a plurality of risks as aforesaid. As before, various features of this aspect may be substituted with or added to by the aforesaid features relating to additional numerical effect, risk characteristics and parameters, and so on.

The present method may further comprise processing the at least one estimate to select a mitigation process to reduce the effect of the type of risk on the technical system.

As noted elsewhere, the present aspect may further comprise any appropriate aforesaid feature, for example including but not limited to other features relating to mitigation processes, and features relating to risk characteristics and parameters, and so on.

In another aspect of the invention there is provided computer program code (and/or computer readable medium tangibly embodying such computer program code) which, when executed by one or more processors in one or more computer systems, causes said one or more computer systems to carry out a method as aforesaid.

In a further aspect of the invention there is provided a computer system including at least one processor and associated memory, the memory containing computer program code as aforesaid or otherwise being suitably programmed to carry out a method as aforesaid.

The method of any aspect may further comprise estimating an expected variance for at least one of (a) each estimated numerical effect and (b) each likelihood of occurrence. The method may further comprise generating a mathematical function (the same or additional to the current generated function) having an output including the estimated variance. The variance may be in the classical sense or otherwise provide some indication of an expected range of outputs (for example in conjunction with a particular likelihood of the results being within that range, or in accordance with some other appropriate treatment of and/or combination of error and likelihood).

Although the embodiments of the invention described herein with reference to the drawings may comprise computer-related methods or apparatus, the invention may also extend to program instructions, particularly program instructions on or in a carrier, adapted for carrying out the processes of the invention or for causing a computer to perform as the computer apparatus of the invention. Programs may be in the form of source code, object code, a code intermediate source, such as in partially compiled form, or any other form suitable for use in the implementation of the processes according to the invention. The carrier may be any entity or device capable of carrying the program instructions.

For example, the carrier may comprise a storage medium, such as a ROM, for example a CD ROM or a semiconductor ROM, or a magnetic recording medium, for example a floppy disc, hard disc, or flash memory, optical memory, and so on. Further, the carrier may be a transmissible carrier such as an electrical or optical signal which may be conveyed via electrical or optical cable or by radio or other means. When a program is embodied in a signal which may be conveyed directly by cable, the carrier may be constituted by such cable or other device or means.

Although various aspects and embodiments of the present invention have been described separately above, any of the aspects and features of the present invention can be used in conjunction with any other aspect, embodiment or feature where appropriate. For example apparatus features may where appropriate be interchanged with method features. References to single entities should, where appropriate, be considered generally applicable to multiple entities and vice versa. Unless otherwise stated herein, no feature described herein should be considered to be incompatible with any other, unless such a combination is clearly and inherently incompatible. Accordingly, it should generally be envisaged that each and every separate feature disclosed in the introduction, description and drawings is combinable in any appropriate way with any other unless (as noted above) explicitly or clearly incompatible.

### BRIEF DESCRIPTION OF THE DRAWINGS

The invention will now be described further, by way of example, with reference to the accompanying drawings, in which:

FIG. 1 is a schematic of technical system which may be susceptible to different types of risk;

FIG. 2 is a graph showing possible variations to an internal state of the technical system of FIG. 1 due to different types of risk;

FIG. 3 is a schematic of a diesel generator, illustrating some specific types of risk;

FIG. 4 is a graph showing the potential impact of a contamination risk on the diesel power output of the diesel generator of FIG. 3;

FIG. 5 is a graph showing the potential impact of a mechanical wear risk on the diesel power output of the diesel generator of FIG. 3;

FIG. 6 is a graph showing the estimated numerical effect on the output of the diesel generator of FIG. 3 as the speed of onset of a mechanical wear risk is varied;

FIG. 7 is a graph showing the estimated likelihood of occurrence of a mechanical wear risk as the speed of onset of the mechanical wear is varied;

FIG. 8 is a graph showing points corresponding to the estimated numerical effect and estimated likelihood of occurrence of FIGS. 6 and 7 for four different parameters of the risk characteristic;

FIG. 9 is a graph showing the points of FIG. 8 with curves fitted to them;

FIG. 10 is a schematic of a power grid system, illustrating some specific types of risk;

FIG. 11 is a graph showing the potential impact of an unexpected supply disruption shock risk on the power supply of the power grid of FIG. 10;

FIG. 12 is a graph showing the potential impact of an excess demand trend risk on a shortfall of power supply to consumers on the power grid of FIG. 10;

FIG. 13 is a graph illustrating the risk of FIG. 12 by plotting likelihood versus numerical effect for four different parameters of the risk characteristic;

FIG. 14 is a flowchart of a method of facilitating the estimation of the effect on a technical system of a risk;

FIG. 15 is a flowchart of a further method of facilitating the estimation of the effect on a technical system of a risk;

FIG. 16 is a flowchart of a yet further method of facilitating the estimation of the effect on a technical system of a risk;

FIG. 17 is a flowchart of a method of facilitating the estimation of the effect on a technical system of a plurality of risks;

FIG. 18 is a schematic of a set of models of types of risk and a model of a technical system;

FIG. 19 is a schematic of the interrelationship of different risk models;

FIG. 20 is an illustration of different types of interrelationship between different risk models;

FIG. 21 is an illustration of the interrelationship between specific types of risk affecting a large scale technical system;

FIG. 22 is an illustration of the range of numerical effects and the range of likelihood of occurrence of various risks which may affect a power grid;

FIG. 23 is an illustration of the application of a predefined scenario to a technical system model representing the power grid of FIG. 22;

FIG. 24 is a schematic of a system for creating and/or updating a risk model;

FIG. 25 is a schematic of the external data analysis module of FIG. 24;

FIG. 26 is a graph showing the derivation of a likelihood of occurrence of a risk from a time series;

FIG. 27 is a schematic of a system for carrying out a mitigation process on a technical system based on an estimate of the numerical effect of a type of risk;

FIG. 28 is a chart plotting the likelihood of occurrence vs proportion of system capacity at risk for a plurality of values of a parameter determining risk characteristics;

FIG. 29 is a chart showing one of the types of risk of FIG. 28 before and after various mitigation processes are applied; and

FIG. 30 is a chart showing a method of generating an estimate of the likelihood of occurrence of a type of risk based on sampling multiple time periods of a time series related to the risk.

### Detailed Description of the Preferred Embodiment(s)

The preferred embodiment provides a method (and related apparatus features) for the estimation of the effect of different types of risk on a technical system. Various aspects and features of the method and apparatus features will now be described.

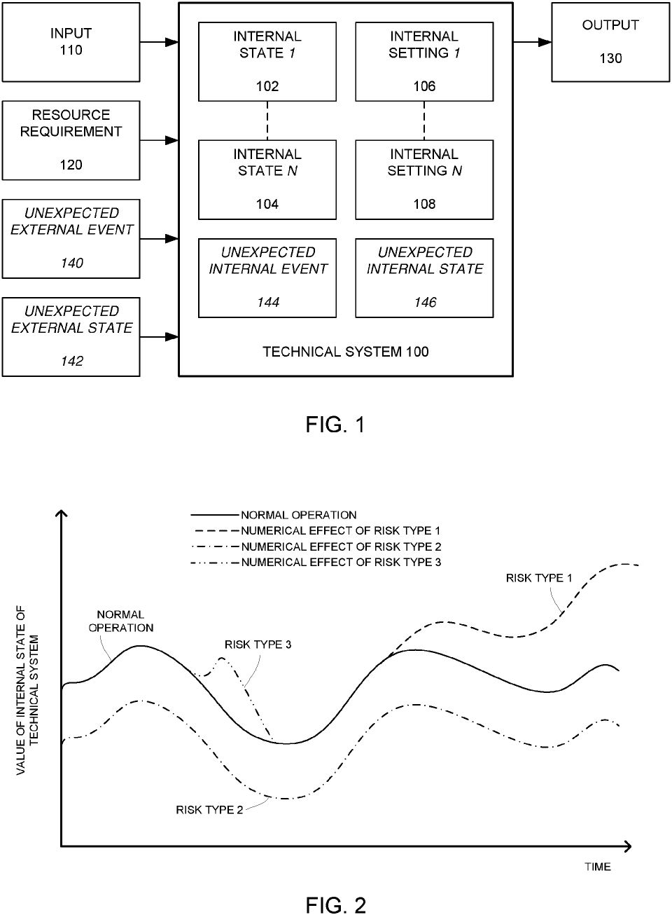

FIG. 1 is a schematic of technical system which may be susceptible to different types of risk. A typical technical system 100 (for example provincial, national or global in scale, such as a power grid system, or a smaller scale system such as a computer network), is susceptible to various risks that may cause poor performance, total failure, and the like. A typical system 100 may for example include a number 1...N of internal states 102, 104 which determine how the system is operating, and a number 1...N of internal settings 106, 108 which dictate how the system is instructed to operate. The system 100 may typically have one or more inputs 110, whether physical or electronic or other commands, and the like, as well as one or more resource requirements 120 such as an electrical power supply. In the normal course of events, the system 100 produces one or more outputs 130 of any appropriate type, whether physical, electrical, information or otherwise.

In the present case it is assumed that the technical system is a machine in a classical sense or otherwise causes a meaningful transformation of some sort, and is not limited to abstract ideas, laws of nature or natural phenomena, for example (though of course it may be influenced by natural phenomena, as explained below).

Being a real-world system, system 100 is susceptible to risks both internal and external. The risks may for example include one or more unexpected external events 140 (such as something breaking or an abrupt chance in circumstances), or an unexpected external state (or ‘unexpected externality’) 142 (such as a change in prevailing environmental or other conditions), and also an unexpected internal event 144 or unexpected internal (change of) state.

During a design process or during operation, it may be possible to identify types or classes of risk which may affect a technical system 100, but in general it is not immediately clear which types of risk pose the greatest risk and how they can most effectively be mitigated. For example, there may be mitigation processes (including reconfiguration, replacement or modification of parts of the system) which may provide reasonable protection against certain types of risk, but at a cost which is prohibitive. Or it may be that some risks can be mitigated against, but for reasons of cost or for technical reasons (or simple incompatibility between different mitigation strategies) it may not be possible to mitigate against all risks at once. For many systems, simply identifying which risks may have a ‘low’ or ‘high’ impact (or similar), or identifying ‘likely’ or ‘unlikely’ risks (or similar) is not sufficient. Also it is often not sufficient to treat a type of risk as having a single expected effect or likelihood, as often risks have characteristics that can vary unpredictably. It can therefore be useful to consider at least a range of possible characteristics relating to a particular type of risk.

FIG. 2 is a graph showing possible variations to an internal state of the technical system of FIG. 1 due to different types of risk. The state (such as an electrical signal level associated with a part of the system) may typically have a preferred level or shape which is indicative of normal operation. Such a signal is indicated in FIG. 2 with a solid line. In the event of an internal or external effect caused by an unexpected event or state associated with different risks, the state/signal level may be changed in a measurable way. FIG. 2 shows possible effects on the state caused by three different risks, with the new waveform/state being shown in various types of dotted and dashed lines. Risk type 1, for example, may cause the state to grow beyond the optimal level at some point in future. Risk type 2, for example, may cause the overall state/signal level to drop by a predetermined (or otherwise) amount. Risk type 3, for example, may cause a momentary spike or deviation from the normal state. Other types of effect are of course possible.

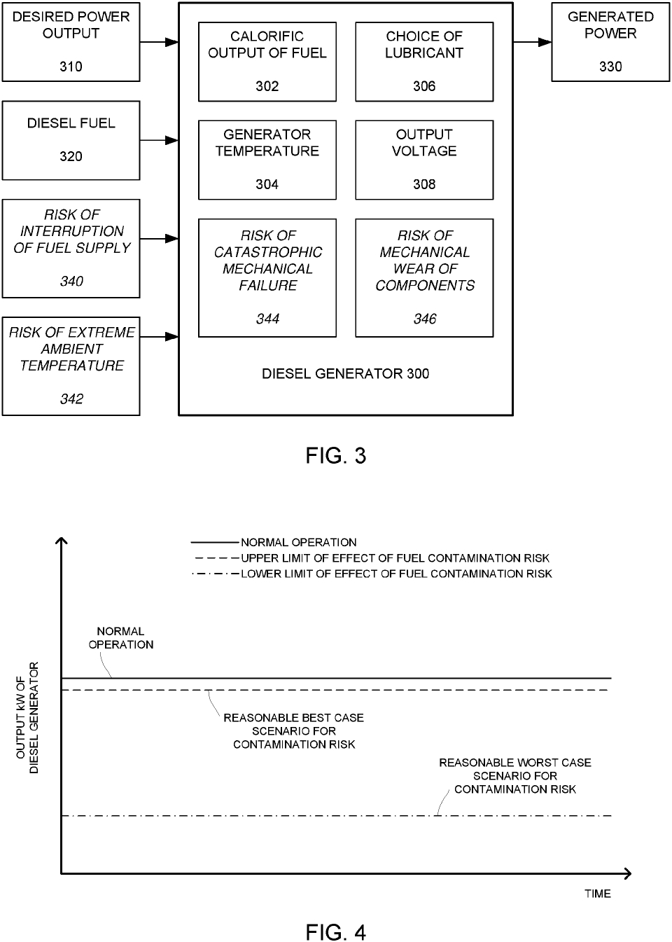

FIG. 3 is a schematic of a diesel generator, illustrating some specific types of risk, to illustrate some of the points made above. The generator 300 has states including the current calorific output of the fuel burned 302 (dependent on the quality of the fuel, and the performance of the engine, amongst other things), a generator temperature 304. The generator 300 has settings (broadly speaking) including a choice of lubricant 306 and a selected output voltage 308. The system 300 has an input 310 of a desired power output (though this could equally be represented as a setting of the generator), and a resource input of diesel fuel 320. The generator system produces an output of electrical power.

The generator 300 is susceptible to various risks including the risk of interruption of fuel supply 340, a risk of an extreme ambient temperature 342 (threatening an overheat condition), a risk of catastrophic mechanical failure 344, and a risk of mechanical wear of components 346.

FIG. 4 is a graph showing the potential impact of a contamination risk on the diesel power output of the diesel generator of FIG. 3. In this specific case, it can be seen that the effect of contaminated fuel is likely to reduce the output of the generator. The numerical extent of the reduction may vary depending on the degree or type of contamination, for example. A diesel generator in a maritime environment may be susceptible to salt water ingress, for example.

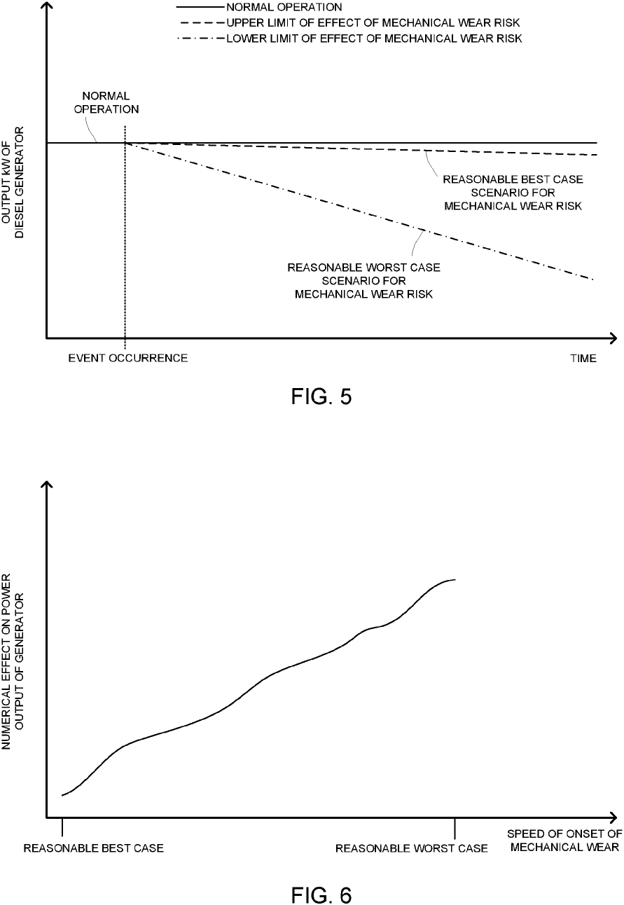

FIG. 5 is a graph showing the potential impact of a mechanical wear risk on the diesel power output of the diesel generator of FIG. 3. Here the effect of the risk may be a reduction in the power output again, but the reduction varies both by severity of the risk/wear but also varies according to a speed of onset of the mechanical wear. Thus the type of risk (mechanical wear) is in this case defined at least partly by two separate characteristics (severity and speed of onset). In other cases, a type of risk might be defined by one characteristic but defined by more than one parameter, or by any appropriate combination of these possibilities.

The reasonable best and worst case scenario are indicated on FIG. 5 with dashed and dotted and dashed lines. In this case, ‘reasonable’ implies a likelihood of occurrence above a certain threshold, for example such as above 5% probability, or similar. Other thresholds may be chosen.

FIG. 6 is a graph showing the estimated numerical effect on the output of the diesel generator of FIG. 3 as the speed of onset of a mechanical wear risk is varied. This essentially shows the derivation of the gradient of the best case and worst case lines in FIG. 5 in dependence on the speed of onset of mechanical wear. This graph may be derived from an estimation (or calculation) based on a model of the system or otherwise (more on which, see below).

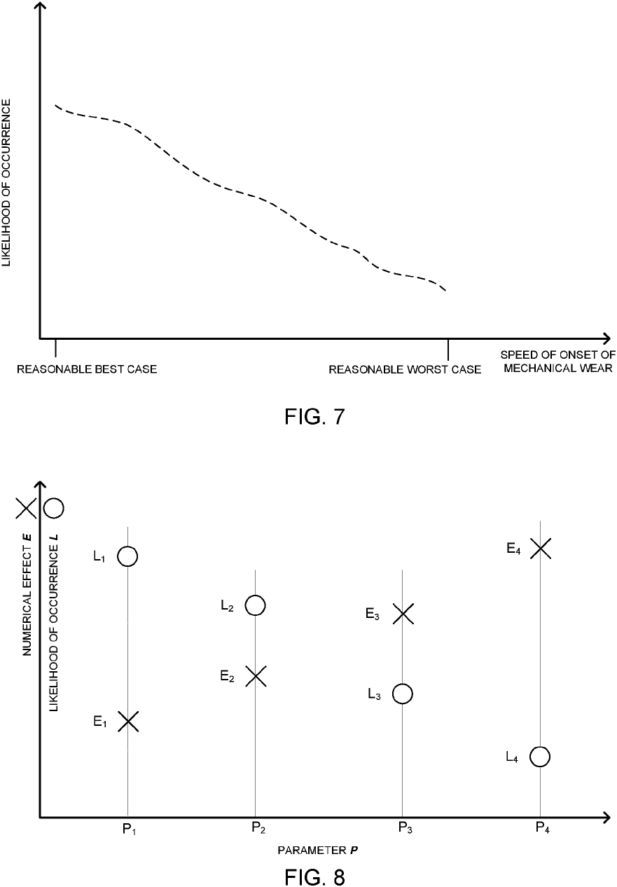

FIG. 7 is a graph showing the estimated likelihood of occurrence of a mechanical wear risk as the speed of onset of the mechanical wear is varied. This is essentially an analogue of FIG. 6 but for likelihood of occurrence rather than numerical effect. It can be seen that the reasonable best case (in terms of numerical effect) is more likely to occur than the reasonable worst case, for example, though this need not be true and the graph need not be any particular shape.

FIG. 8 is a graph showing points corresponding to the estimated numerical effect and estimated likelihood of occurrence of FIGS. 6 and 7 for four different parameters of the risk characteristic. The selection of the four parameters P₁, P₂, P₃ and P₄, corresponding to different respective speeds of onset, may be made according to any appropriate principle. The values of the parameters may be chosen, selected or computed so as to space them out equally from each other, but they need not. The selection of parameters may be made by an operator but may also be made in accordance with an appropriate algorithm and so on. In effect, four separate samples of numerical effect and likelihood of occurrence have been taken at the four points on the graph.

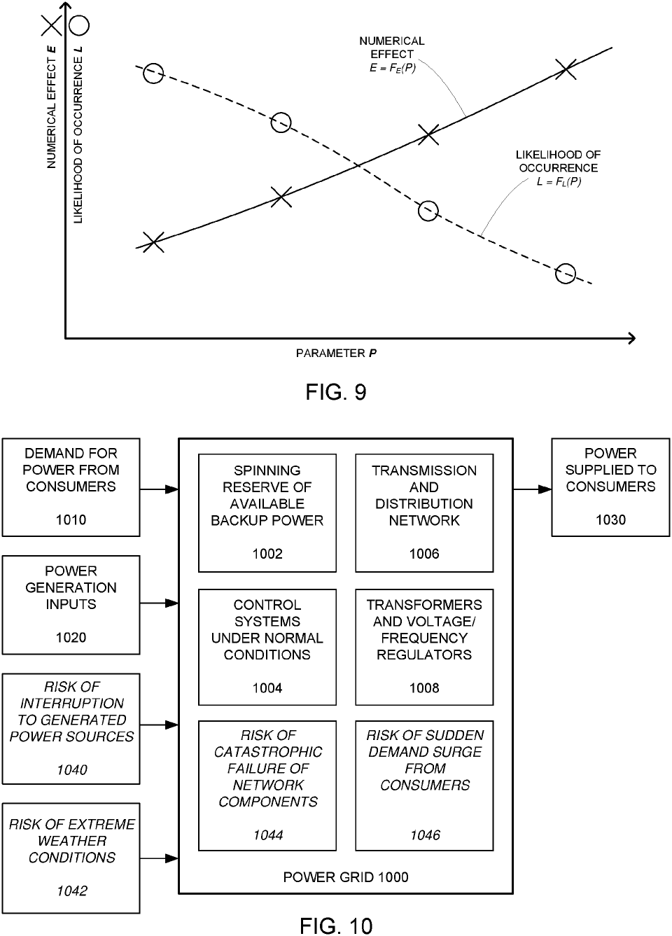

FIG. 9 is a graph showing the points of FIG. 8 with curves fitted to them. Here the sample pairs of values have been processed in an appropriate way to generalise the samples (four or otherwise, more or less) into a mathematical function which takes an input of a parameter value and outputs one or both of a corresponding numerical effect and likelihood of occurrence. In this case, the function takes a continuous, real input but it could alternatively be a discrete function, taking integers as an input or otherwise.

The numerical effect (E) and likelihood (L) for a particular parameter value (P) defining a characteristic of a relevant type of risk (R) can then be expressed as:

$$E = {F}_{E} \left(P\right) \qquad \text{(1)}$$

$$L = {F}_{L} \left(P\right) \qquad \text{(2)}$$

In effect, what has been done is to sample a possibly mathematically complex function or model (or similar) at a relatively small number of points, and to generate (potentially) simpler mathematical function(s) which essentially fit a curve to those sampled points. An appropriate selection of parameter values can improve the accuracy of the generated function(s).

FIG. 10 is a schematic of a power grid system, illustrating other types of risk.

Similarly to the diesel generator example given above, the power grid 1000 has states (including spinning reserve of available backup power 1002 and a collection of states relating to the control systems operating under normal conditions 1004), and various inputs and outputs, and transformative elements (such as the transmission and distribution network 1006 and transformers and voltage/frequency regulators 1008) which all interconnect in various ways.

In contrast to the diesel generator, whose output is substantially deterministically derivable from a particular set of inputs and internal states, the power grid is an example of a complex system. A complex system can be understood to be a system composed of many components which may interact with each other and where linear inputs can result in nonlinear outputs because of the interaction of the component parts. Outputs of a complex system can for example include ‘emergent behaviour’. Examples of complex systems include the Earth’s global climate, organisms, infrastructure such as a power grid, transportation or communication systems, ecosystems, and so on. Put another way: the output of a complex system is not in general deterministically derivable from a knowledge of inputs of the system (or furthermore from a knowledge both of inputs into the system and appropriate internal states of the system).

A complex system may additionally or alternatively be defined as a system having a defined range of inputs, outputs and/or internal states which can be expected to lead to, or which is sought in order to obtain, stable or predictable operation. In this context, risks can be understood as an input variable, output variable or internal state that is outside this defined range of inputs, outputs and/or internal states. The precise effects of a risk on a complex system are typically not possible to predict or calculate, and this prevents effective use of many conventional control systems and methods (notably linear control systems) to control the complex system. It may nevertheless be possible to determine or calculate statistical properties relating to the potential impact of a risk on individual components, states or outputs of the system.

The inputs into the power grid 1000 include an aggregate demand for power from consumers 1010, power generation inputs 1020, and has an output of the power supplied to consumers (ideally equal to the demand 1010). The power grid is susceptible to various risks including the risk of interruption to generated power sources 1040, a risk of extreme weather conditions 1042 (threatening an overheat condition), a risk of catastrophic failure of network components 1044, and a risk of sudden demand surge from consumers 1046.

FIG. 11 is a graph showing the potential impact of an unexpected supply disruption shock risk on the power supply of the power grid of FIG. 10.

For ease of understanding, the risk is presented in a different format to FIGS. 4 and 5.

The dashed line represents a reasonable best case scenario for a supply shock risk (for example circuit breakers causing a temporary disconnection of a low power output wind farm from the power grid, or similar). The limit of the power loss is indicated by a dotted line. After a relatively short time, the power output level associated with normal operation is resumed.

The dotted and dashed line represents a reasonable worst case scenario for a supply shock risk (for example, a large nuclear power station carrying out an emergency reactor shut down). The limit of the power loss is indicated again by a dotted line. In this case, a relatively long time passes before normal operation is resumed (this length of effect variable is not here modelled separately but can be).

As before, ‘reasonable’ may imply a likelihood of occurrence above a certain threshold, for example such as above 5% probability, or similar. Other thresholds may be chosen.

The data plotted on FIG. 11 is also applicable to the potential impact of an extreme weather event, such as an ice storm, on the output of the power grid of FIG. 3. In this specific case, it can be seen that the effect of the weather event is likely to reduce the output of the power grid. The numerical extent of the reduction may vary depending on the severity of the weather event or its location, for example. The duration of the event and speed of recovery of the system determines the shortfall of supply to power consumers, consisting of the lost output combined with the duration of the loss. The reasonable best case results in a small reduction for a limited time and rapid restitution of normal function. The reasonable worst case scenario results in a major reduction in output, sustained for a long period, and then a lengthy period for restitution back to normal levels of service. The total shortfall from the reasonable worst case scenario is considerably larger than the reasonable best case scenario, in terms of lost output combined with duration of loss.

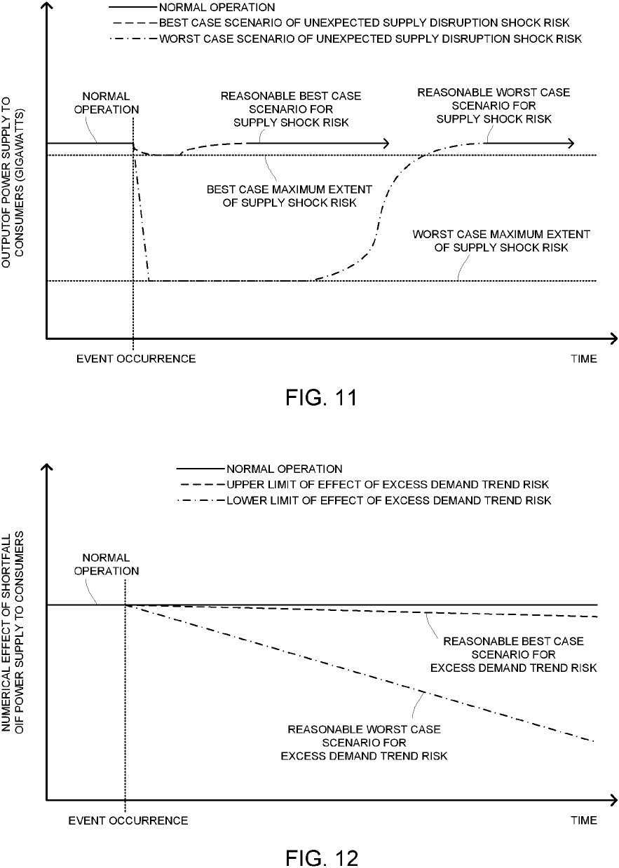

FIG. 12 is a graph showing the potential impact of excess demand trend risk on the output of the power grid of FIG. 10, produced for example by population increase in the region served by the grid. Here the effect of the risk may be a shortfall against the demand again, but the reduction varies by the rate of future population increase, which is unknown, but may vary between the reasonable best case scenario of relative slow rate of population increase, to the reasonable worst case scenario of a high rate of population increase, resulting in a rapid increase in the shortfall of the powergrid in supplying the demand.

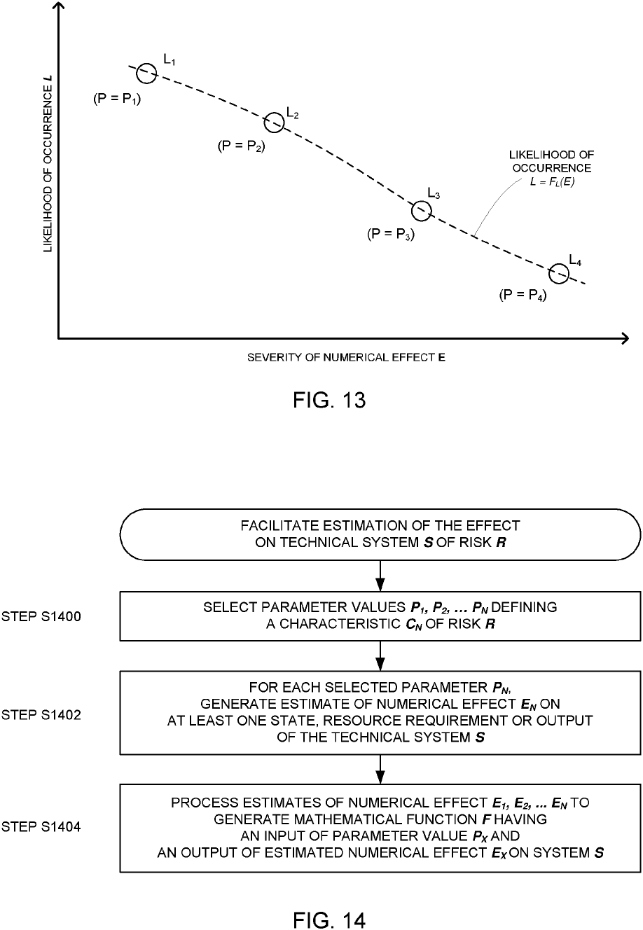

FIG. 13 is a graph illustrating the risk of FIG. 12 by plotting likelihood versus numerical effect for four different parameters of the risk characteristic. This presents the data of FIG. 12 in a different form to that shown in FIG. 9. This form of graph may be referred to as an exceedance probability distribution.

The line of FIG. 13 defines the variation of likelihood of occurrence of the risk in dependence on numerical effect of the risk (and vice versa). Four different specific likelihoods L₁-L₄ (optionally associated with four different parameters P₁-P₄) are shown on the graph. Four specific numerical effects could equally be chosen. A graph of this form can assist in understanding the effect both of common risks and outlier events.

FIG. 14 is a flowchart of a method of facilitating the estimation of the effect on a technical system of a risk. This flowchart essentially codifies the process steps described above. In step S 1400, parameter values P_{1..N}, defining a characteristic C of a type of risk R, are selected.

In step S 1402, an estimate of the numerical effect E_{N} of the risk on the technical system S (and in particular the effect on at least one state, resource requirement or output of the system) is generated, and this is done for each of the parameters P_{1..N}. The estimation may be made by any appropriate means, for example using any number of models or mathematical functions, by fitting to historical or other data, or otherwise.

In step S 1404, the generated estimates E_{1..N} are processed (for example by curve fitting, least squares estimation, and so on) to create a mathematical function F (or model, or other appropriate representation, generalisation, or simplification) which maps an input parameter value P_{X} to an output E_{X} corresponding to an estimated numerical effect on the system S. The function F can then be used as appropriate to provide a simplified and generalised indication of the estimated numerical effect of the type of risk, allowing the risk to be analysed across all reasonable ranges of the parameter defining the risk characteristic.

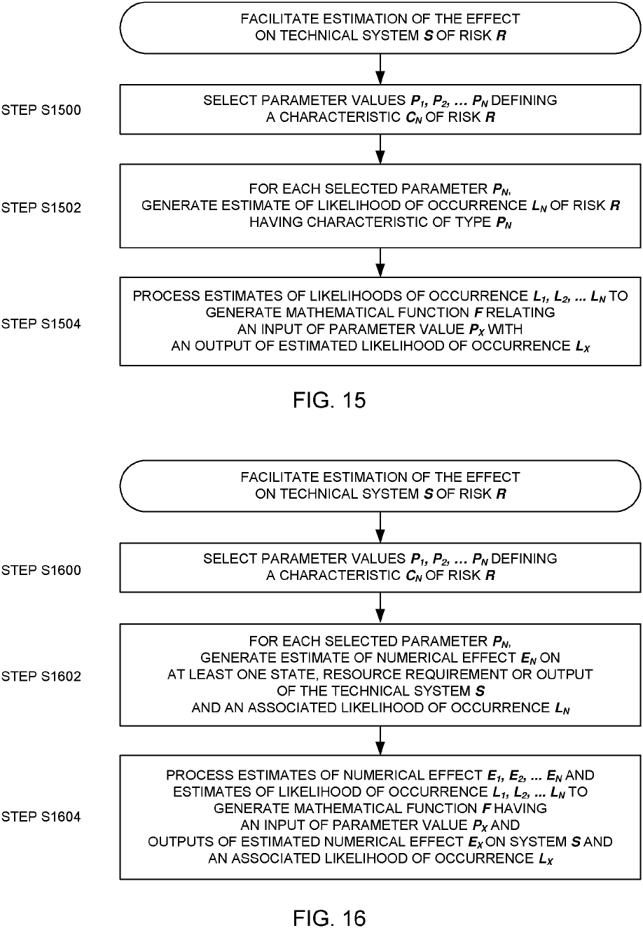

FIG. 15 is a flowchart of a further method of facilitating the estimation of the effect on a technical system of a risk.

In step S1500, parameter values P_{1..N}, defining a characteristic C of a type of risk R, are selected, as before. In step S 1002, an estimate of the likelihood of occurrence L_{N} of the risk is generated, and this is done for each of the parameters P_{1..N}. In step S1504, the generated estimates L_{1..N} are processed (for example by curve fitting, least squares estimation, and so on) to create a mathematical function F (or model, or other appropriate representation, generalisation, or simplification) which maps an input parameter value P_{X} to an output L_{X} corresponding to an estimated likelihood of occurrence.

FIG. 16 is a flowchart of a yet further method of facilitating the estimation of the effect on a technical system of a risk. This process essentially combines the processes of FIGS. 10 and 11. In FIG. 16, parameter values P_{1..N} are selected as before (step S1600), and for each selected parameter P_{1..N}, estimates of the numerical effect E_{N} and the likelihood of occurrence L_{N} are generated (S1602). In step S1604, the estimates are processed as before to generate a function F which outputs an estimate of the numeric effect E_{X} of the risk on the system S and an associated likelihood L_{X} of the risk occurring, based on an input risk characteristic parameter value (P_{X}). The combination of estimated numeric effect and likelihood of occurrence provides a powerful synergy for a process of estimating and mitigating against types of risk.

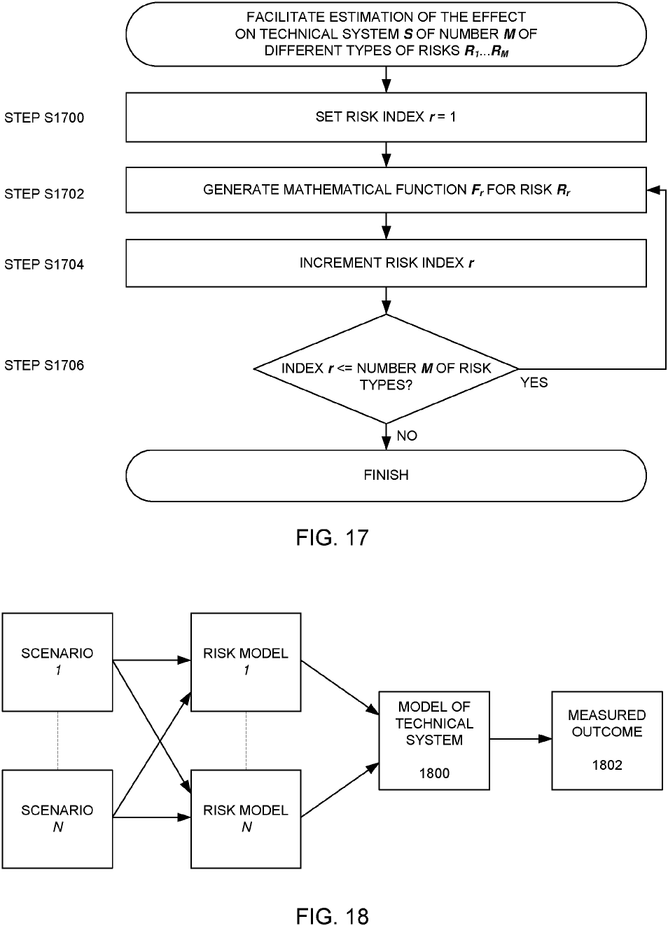

FIG. 17 is a flowchart of a method of facilitating the estimation of the effect on a technical system of a plurality of risks (as opposed to just one type of risk). In step S1700, the risk index r is set to the first index (with the first index in this case being defined as 1). In step S 1702, a mathematical function Fᵣ is generated for the selected risk Rᵣ, in accordance with the process of any of FIGS. 10 to 12 described above. In step S1704, the risk index r is incremented, and if a test concludes that the process is completed for all risks (S1706), the next function is generated (S1702 again). Otherwise the process finishes with all functions F_{1..M} generated for each respective risk R_{1..M}. This can allow a comprehensive modelling or consideration of a wide range of risks simultaneously.

FIG. 18 is a schematic of a set of models of types of risk and a model of a technical system. In this case a model 1800 is provided of the technical system (by any appropriate means and using any appropriate modelling techniques), and an outcome 1802 is measured, indicative of the numeric effects of a number of models 1..N of types of risks as aforesaid. Any number of scenarios 1..N can be provided, which specify any number of types of risks to apply to the model of the technical system 1800, whereby to determine a resulting numerical effect of the specified risks. Multiple scenarios can be combined where appropriate to carry out more complex tests of the resilience of the technical system. Actions may be taken in response to determining the numeric effect of the risks in accordance (where appropriate) with applied scenarios. Scenarios can be generated by operators or may be generated within this or any other computer system, either stochastically (randomly) or otherwise, for example drawing on historical data or by considering the likelihood of occurrence of various risks (for example using their generated functions of likelihood of occurrence).

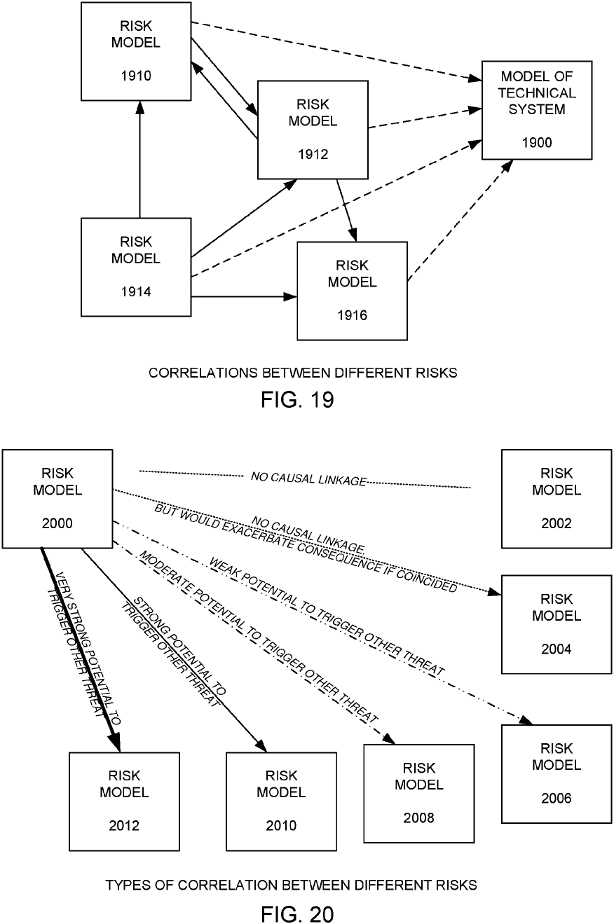

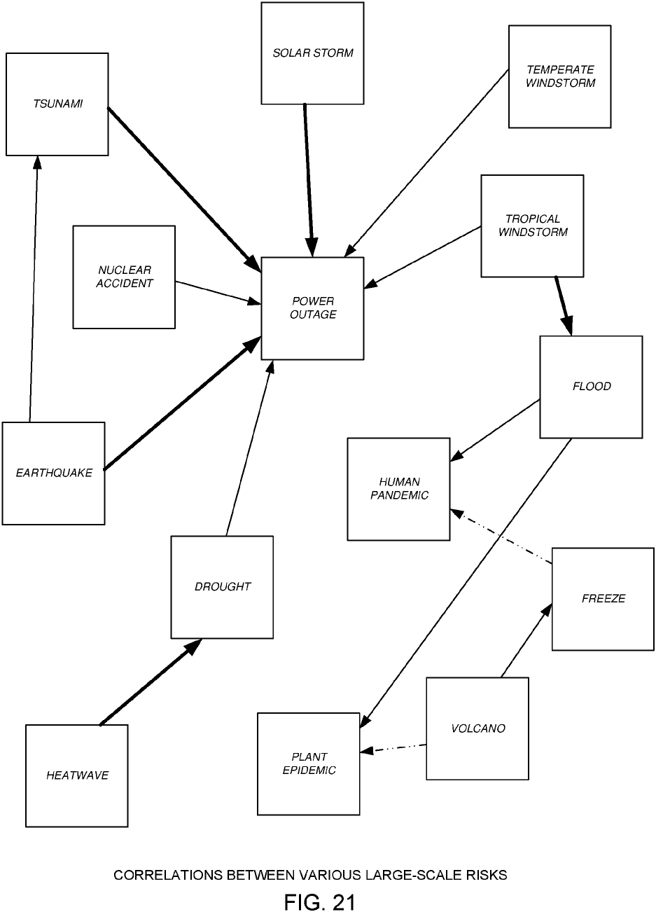

FIG. 19 is a schematic of the interrelationship of different risk models. It has traditionally not been taken into account that certain types of risk are correlated in various ways with other types of risk. However, this can make a significant contribution to the effect of risks on a system. In this case, a model of a technical system 1900 is shown, along with various risk models 1910, 1912, 1914, 1916. Dashed lines indicate a dependence of the system model 1900 on the risks. Solid lines indicated causative relationships between the different risk models. For example risk model 1910 and risk model 1912 are mutually correlated, whereby the occurrence of one risk type will usually be associated with the other. More often risks have a one-way correlation, whereby (for example) the occurrence of risk 1914 has a causative effect with regard to other risks 1910, 1912 and 1916. Risk 1916 does not have a causative effect on any other risk types, but other risk types can have a causative effect on it. This interrelationship between risk types will now be described in more detail.

FIG. 20 is an illustration of different types of interrelationship between different risk models 2000, 2002, 2004, 2006, 2008, 2010, 2012. The line types indicate different types of defined relationship. Examples are given here, but other classifications of relationship and degrees of relationship are of course possible.

In this system of classification, in some cases, there is no causal linkage identified between risks (2000, 2002). The first level of linkage is where there is no causal linkage identified but one risk would exacerbate the consequence of the other risk if they occurred simultaneously (2000, 2004). The second level of linkage is where one risk has a weak potential to trigger the other threat/risk (2000, 2006). The third level of linkage is where one risk has a moderate potential to trigger the other threat/risk (2000, 2008). The fourth level of linkage involves a strong potential to trigger the other threat (2000, 2010). The fifth and final level of linkage involves a very strong potential to trigger the other threat/risk (2000, 2012).

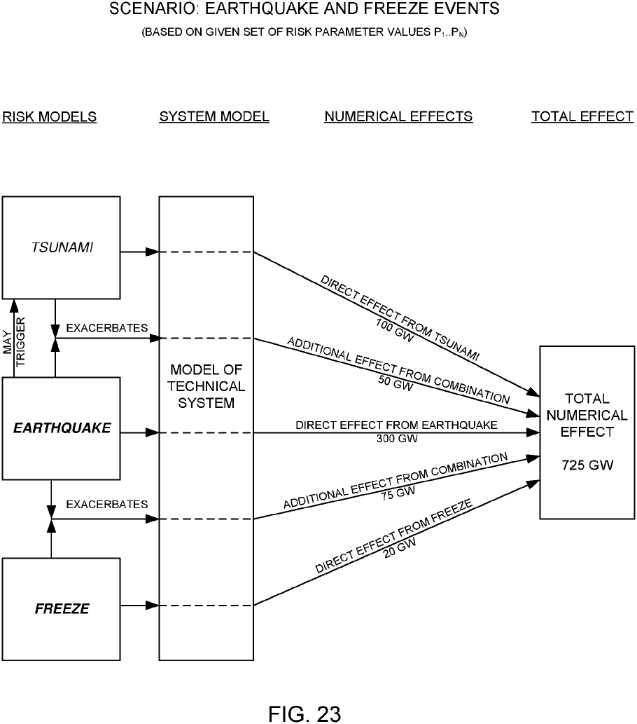

FIG. 23 is an illustration of the interrelationship between specific types of risk affecting an example of a large scale technical system. In this case the system is a power grid, having an output that can be defined as the current capacity of the grid (in gigawatts, for example). FIG. 23 illustrates certain environmental risks which the system may be subject to. The risks include tsunami, solar storm, temperate windstorm, tropical windstorm, fallout from a nuclear accident within the vicinity, power outage, flood, earthquake, human pandemic, freeze, drought, heatwave, plant epidemic and volcanic eruption.

A subset of the relationships/correlations between different risks is shown: weak correlations/causations are shown with a dotted and dashed line. Strong correlations/causations are shown with a solid line, and very strong correlations/causations are shown with a solid and extra thick line. It can be seen that power outage is a key risk that can be triggered by many other risks. Other triggering and triggered risks may be defined; the risks shown here are not exhaustive. For example societal and financial risks may be considered. These sorts of risks can be harder to predict, but can still be done so relatively objectively, and the non-technical risks such as these may still be technically relevant because of the effects that they may in turn have on technical aspects of the technical system. For the present purposes, however, non-technical risks will be omitted from consideration in relation to the map of related risks in this figure.

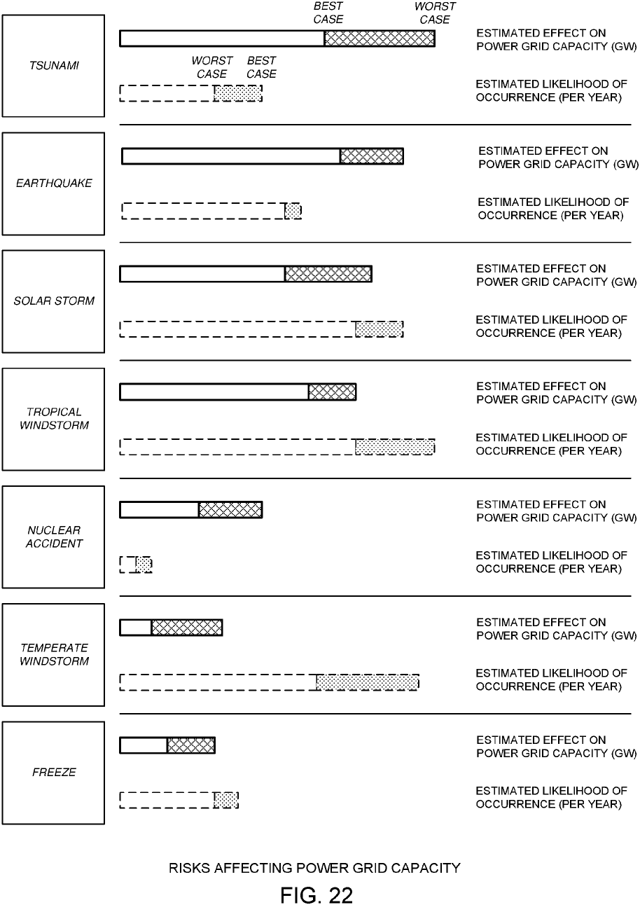

FIG. 22 is an illustration of the range of numerical effects and the range of likelihood of occurrence of various risks which may affect a power grid. By applying principles described above, the numeric effect and likelihood of occurrence of each potentially related risk can be ascertained, with best and worst cases (and values in between) determined by appropriate use of parameters of defining characteristics of each risk. In some cases (such as tsunamis) the possible numeric effect on the system (in this case, grid capacity lost) may be high, but the likelihood of occurrence may be low. In other cases (such as temperate windstorms), the numeric effect on the system may be relatively low but the likelihood of occurrence may be high. In yet further cases, the variance of the estimates is relatively high, and in others it is relatively low. This is defined by the nature of the risk and the specific details of any model, and so on.

FIG. 23 is an illustration of the application of a predefined scenario to a technical system model representing the power grid of FIG. 22. In this case, two scenarios are applied: earthquake and freeze (sustained period of very low temperature) events. The earthquake and freeze models are applied, via the system model, making a direct contribution to the numerical effect of lost grid capacity of 500 GW or so. However, it is established that the earthquake risk has a strong causative relationship with the tsunami risk. Accordingly, an additional direct effect of 100 GW or so is added corresponding to the effect of the tsunami. Yet further, the correlations between the risks determines that the combination of an earthquake with a tsunami creates an additional 50 GW of exacerbated effect, and the combination of a freeze event with an earthquake event may be determined to add an additional 75 GW loss, for example. The freeze event occurs coincidentally. The earthquake is not caused by the freeze event, nor the freeze event by the earthquake, but when they occur together the effects are compounded and exacerbate the total numerical effect. Various approaches can be taken to sensibly combine different risks having different likelihoods of occurrence into meaningful combined statistics or conclusions.

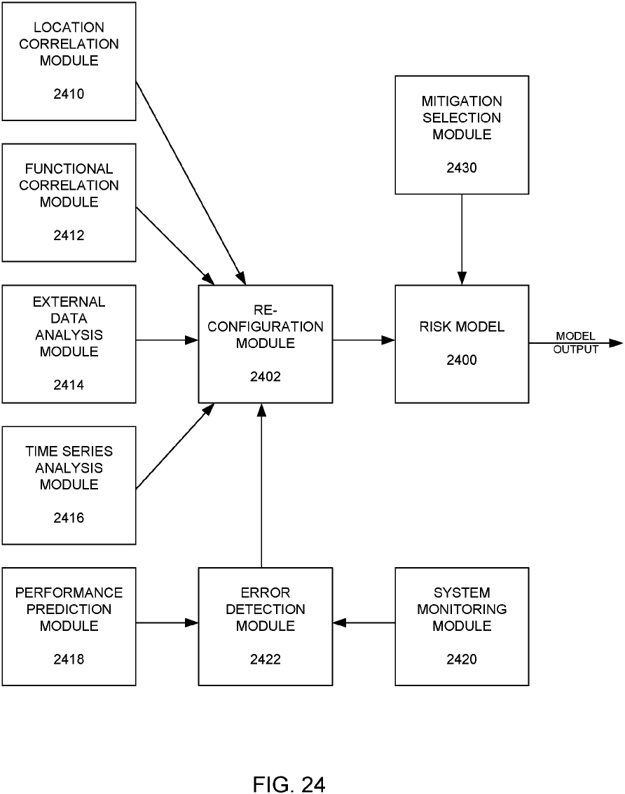

FIG. 24 is a schematic of a system for creating and/or updating a risk model. A risk model 2400 may be created or updated by a reconfiguration model 2402, which can alter parameters or components of the risk model 2400 as needed. The reconfiguration model 2402 receives data from various sources, and processes the received data (for example in accordance with machine learning and/or other AI methods) to determine a correction to or configuration of the risk model 2400. For any particular embodiment, the data sources may include one or more of a location correlation module 2410, a functional correlation module 2412, an external data analysis module 2414, a time series analysis module 2416, and a performance prediction module 2418 the output of which can be compared by an error detection module 2422 to a measured performance 2420 of the technical system.

In more detail, the location correlation module 2410 identifies or groups (or tracks) components of the system having a defined geographical relationship (either at a large scale or small scale). In terms of large scales, the location correlation module 2410 may flag that a particular group of system components are geographically related. For risks which have a geographical origin (such as tropical windstorms), the model can for example be simplified or made more accurate by use of such grouping, and so on.

The functional correlation module 2412 is similar to the location correlation module 2410 but identifies and/or groups parts of the system which are functionally interrelated. For some types of risk, it is likely that if one part of the system is affected, parts of the system which are closely functionally related may also be expected to be affected.

The external data analysis module 2414 is described in more detail below.

The time series analysis module 2416 is a specific type of external data analysis module which considers time series of values that are at least partly related to types of risk in question.

The performance prediction module 2418 may for example generate predictions of system performance. These predictions are tested (2422) against observation (2420), and any errors in prediction can be processed to determine new or unexpected trends and the like.

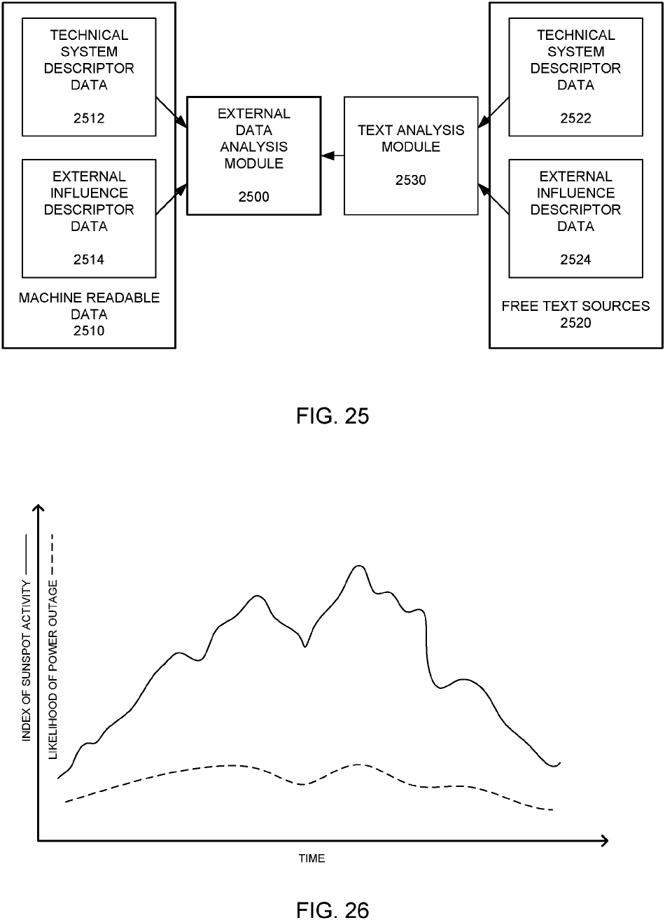

FIG. 25 is a schematic of the external data analysis module of FIG. 20. The external data analysis module 2500 can access both computer-readable data 2510 and free text sources 2520, both sources including technical system descriptor data 2512, 2522 and external influence descriptor data 2514, 2524. The free text sources 2520 are processed with a text analysis module 2530 to generate useful data for the module 2500. The external influence descriptor data is essentially data of any appropriate sort which provides information that is descriptive of influences on the type of risk.

For example, the free text sources could be science journals, in which case the text analysis module 2530 may be programmed to search for keywords and the like relating to specific risks. The text module 2530 could for example search for mentions of volcanic activity and carry out additional processing such as determining whether the mention indicated a positive or negative trend, and determining the number of occurrences of information, indicating the quality of data. A significant increase in mentions of volcanic activity could cause the models for earthquakes and volcanos to be updated with a higher likelihood of occurrence of the particular risk. Similar data can be sought (more easily) in the machine readable data 2510.

The system may include natural language processing or other modules which can improve the effectiveness or efficiency of the data extraction.

FIG. 26 is a graph showing the derivation of a likelihood of occurrence of a risk from a time series. Sunspot activity can be represented as a time series, and may be considered indicative of the risk of a solar storm which may in turn trigger a risk of a power outage. The external data analysis module mentioned above may be programmed to track the sunspot activity (the solid line in FIG. 26) and to revise in real-time (or similar, for example over the course of seconds, minutes or hours) the likelihood of a power outage (the dashed line). In this case, an increase in sunspot activity, in conjunction with historical knowledge of sun spot cycles, may cause the estimate of the likelihood of occurrence to be increased and decreased in accordance with movements of the values of sunspot activity.

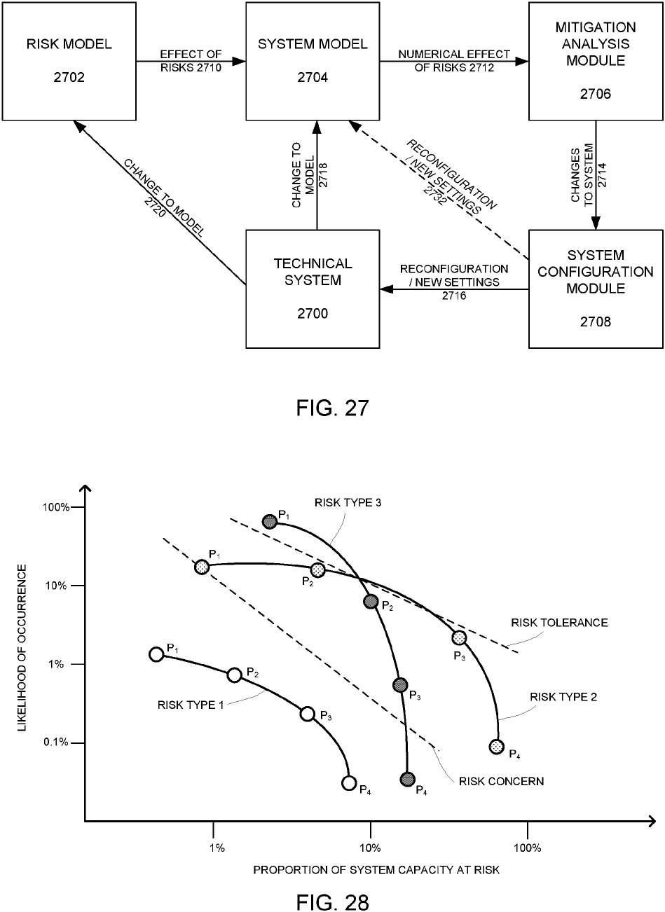

FIG. 27 is a schematic of a system for carrying out a mitigation process on a technical system based on an estimate of the numerical effect of a type of risk. The technical system 2700 is shown, as well as (at least one) risk model 2702, a model 2704 of the technical system, a mitigation analysis module 2706, and a system (re)configuration module 2708. In accordance with an applied scenario (or otherwise) the risk model outputs an effect of the risk 2710, which can be quantified as a numerical effect of the risk 2712 in conjunction with the system model 2704. The mitigation analysis module carries out appropriate processing to create or select a mitigation process intended to reduce or eliminate the effect of the risk 2702 (and preferably others) on the technical system 2700. After selecting the or each appropriate mitigation process, the mitigation analysis module 2706 transmits a set 2714 of desired changes to the technical system to the system (re) configuration module 2708. The list of changes is turned into a specific set of reconfiguration and settings actions and/or commands 2716 which are applied to the technical system 2700. Changes to the technical system can be propagated back to the system model 2704 and risk model 2702, to allow a new model of the reconfigured system 2700 to be created or updated.

The mitigation process can be modelled/simulated rather than immediately implemented, for example, with simulated changes transmitted in transmission 2272, for example. It will be appreciated that various of the blocks shown in FIG. 27 can be combined or omitted as appropriate.

To return to the power grid example of FIG. 10, having determined the numeric effect and likelihood of occurrence of the various risks, mitigation processes can be carried out in accordance with the arrangement shown in FIG. 27. There are two sorts of mitigation which may be carried out: long term/structural and real-time. In terms of structural mitigation, having for example estimated the likelihood and severity of supply shock risk, the risk may be mitigated by increasing generator capacity to a level designed to compensate for an effect that corresponds to a ‘design’ likelihood or similar (that is, the system may as a whole be designed to deal with any 1 in a 100 year events) but no further.

In accordance with a demand trend risk, the risk could be mitigated, for example, by rebalancing the grid and building more transmission capacity in order to route power from elsewhere, and the like, and increase generator capacity where needed.

In terms of real-time mitigation, faster acting and less predictable risks may be mitigated against by appropriate computer control of various components of the power grid. For example, switching of transmission networks can be carried out in real-time in response to triggers associated with specific risks and severity of effect in order to avoid local blackouts and the like. In cases where it is not possible to provide 100% of the expected needed power, for example, a risk control process in accordance with the presently described embodiments can be used to switch an amount of power needed to deal with events within a particular likelihood. For example, if an up to 10 GW shortfall is predicted by analysis of real-time values of inputs, outputs and/or internal states of a power grid, 6 GW, say, may be routed because the risk control system computes that this will be sufficient for everything except once per month events, or similar. A single control signal could then change the target reliability of the system so that, for example, 8 GW may be routed, to cater for once per year events and more common events. The present methods thus allow flexible management of complex (and other) technical systems to allow available technical resources to be maximised.

FIG. 28 is a chart plotting the likelihood of occurrence vs proportion of system capacity at risk for a plurality of values of a parameter determining risk characteristics. Here the pairs of numeric effect and likelihood of occurrence are plotted for ease of visualisation, with samples/points corresponding to selected parameter values (P₁, P₂, P₃, P₄) indicated with circles, and with fitted lines/generated mathematical functions being shown as solid lines. Using these logarithmic scales or otherwise, it is possible to define target constraints for the risks. In this case, a first dashed line indicates areas of risk concern and a second dashed line indicates areas of risk tolerance. Any risks determined to be above the risk concern line (that is, to the left and above) are considered undesirable but not unacceptable. Any risks determined to be above the risk tolerance line will not be tolerated and must be mitigated if possible. Here it can be seen that while none of the sampled pairs P₁...P₄ of numerical effect and likelihood of occurrence for Risk Type 2 are the wrong side of the risk tolerance line, the output of the relevant generalised mathematical formula does produces results (the fitted line) which are. Risk type 2 therefore needs to be mitigated.

Here, in relation to the power grid example, the raw numeric effect is converted into an estimated proportion of the capacity at risk but other representations are possible. This proportion can be determined relatively directly by subtracting the total numerical effect from 100% of the capacity. Losing a large proportion of the capacity, and certainly all of it, would be considered a terrible outcome. High impacts but at relatively low likelihood are more easily tolerated (hence the gradient of the risk concern and risk tolerance lines).

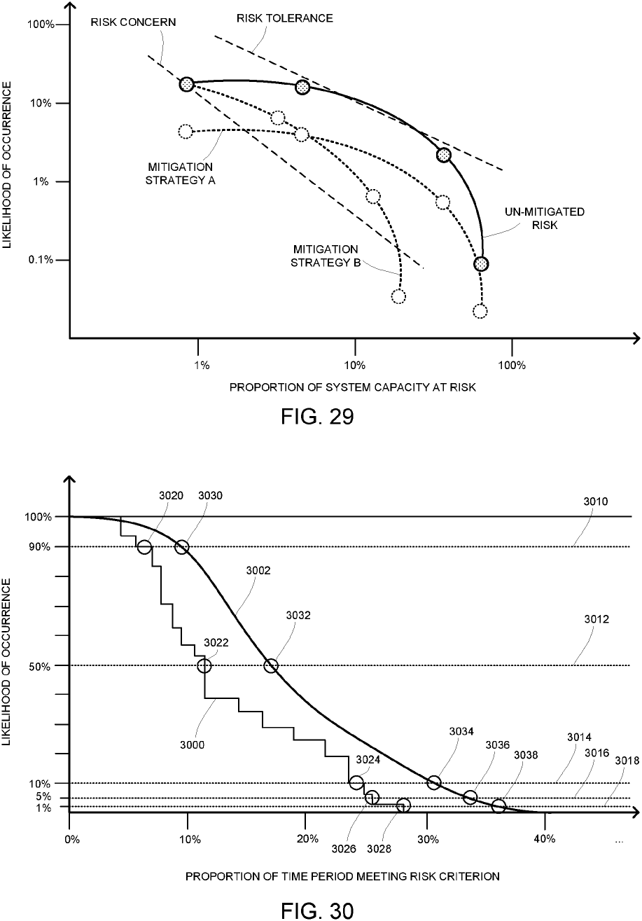

FIG. 29 is a chart showing one of the types of risk of FIG. 29 before and after various mitigation processes are applied. The original plot of system capacity loss vs likelihood of occurrence is indicated with a solid line. Two mitigation processes/strategies are indicated with a dashed line. The first mitigation strategy (A) results in the likelihood of occurrence of the risk universally made less probable, for example as a result of a systemic improvement. This results in the curve being shifted downwards on the graph. The second mitigation strategy (B) results in the likelihood of occurrence being more reduced, the greater the parameter defining the characteristic of the risk. This can result in significant reductions in likelihood for the risk in some circumstances (some parameter values) and relatively small reductions in likelihood for the risk in other circumstances.

A further consideration is that each mitigation process will have a particular cost associated with it. This cost may be literal (money), for ease of comparison, or may be defined in other terms, such as days of downtime, power required, resources required, loss of stability, and so on. Any appropriate algorithm may be applied, preferably automatically or otherwise by an operator and the like, to select the most appropriate mitigation process or processes, bearing in mind the affect each will have across the range of parameters of the relevant risk characteristic and the cost of each. Some kind of optimisation may be applied, for example, to minimise a metric which may depend on one or both of the risk reductions and costs.

In one example, represented by the chart of FIG. 29, the technical system may be a networked computer system, and the relevant type of risk may be a risk of a cyber attack. In this case, the characteristic of the risk may be the extent of the attack, in which case the parameters of that characteristic may represent a proportion of the network which is affected. The lowest value of the parameter (P₁) would refer, for example, to an attack affecting a single computer. the highest value of the parameter (P₄) would refer, for example, to an attack on every single computer in the network.

In this cyber-attack example, mitigation process A would refer to a strategy of improving the patching cadence (speed with which new security patches are rolled out), for example, which would result in generally smaller probabilities of the risk occurring. Mitigation process B, meanwhile, would refer to a strategy of compartmentalising the network. This would not affect an attack on a single computer (P₁) which remains as high a risk as before (albeit with relatively small consequences, so the risk is tolerable). However, it would greatly reduce the risk of an attack on all computers (P₄), due to the difficulty in reaching all of them. It may be that the reduction in likelihood of this most extreme event means that the mitigation process is sufficient. Alternatively, it may be necessary to combine both mitigation processes A and B (at a cost).

Ultimately, both mitigation process A and B achieve the desired objective of reducing the estimated risk below the risk tolerance line, so it will then suffice to choose the process with the smallest associated cost.

FIG. 30 is a chart showing a method of generating an estimate of the likelihood of occurrence of a type of risk based on sampling multiple time periods of a (typically historic but potentially real-time) time series related to the risk. This method is applied to time series data, typically time series that are or can be divided into comparable time periods.

Traditionally, the forecasting of future trends based on historic time series involves calculating averages and estimating future movements of the averages. However accurate or otherwise this approach may be, it was found to be unhelpful for the study of risks, which are typically associated with extreme values. There is a disincentive to study extreme values of time series because for any particular time period (such as a year, for example) they may vary sufficiently ‘wildly’ that they cannot easily be described by traditional statistics. The present embodiment proceeds from the realisation that the data can be analysed from a different perspective which can allow more accurate prediction of extreme events (and therefore can allow more effective estimation of future risk).

In FIG. 30, a plot of a line 3000 can be seen which represents the proportion of each time period meeting a particular risk criterion, and the respective likelihood of occurrence. In one example, the time series may for example chart daily temperatures, and the risk criterion may be the temperature exceeding a threshold temperature (such as 25° C.), a point at which a datacentre may struggle to achieve sufficient cooling (which is associated with a risk of the datacentre failing due to overheating). To take one specific snapshot, a proportion of the time period of 20% is equivalent to 73 days of the year (and a more specific X axis may be used, for example, more directly linked to the time period). If 20 years of time series data are available, the likelihood of occurrence of this 20% proportion is simply equal to the number of years of time series data in which 73 or more days of the year had the temperature above 25° C. divided by the number of years considered. So if this threshold number of days was reached for, say, 8 out of the 20 years studied, the likelihood of occurrence (Y axis) would be 40%. Thus a point on the line 3000 may be plotted at (20%, 40%) on the given axes. If this is repeated for all proportions of the time period (X axis) then a line similar to line 3000 is produced.

This approach is refined by then considering key points on the line, with a particular emphasis at the extreme ends of the scale. Threshold values of likelihood are selected or otherwise determined, in this case at 90%, 50%, 10%, 5% and 1% (other numbers of and selections of threshold are of course possible). The points 3020, 3022, 3024, 3026, 3028 where the historic or real-time data curve 3000 crosses these thresholds 3010, 3012, 3014, 3016, 3018 are recorded.

The points are then processed in any appropriate manner to estimate future values, for example by applying them to risk and/or technical system models. The points are thus projected (typically forwards, in climate scenarios) to new points 3030, 3032, 3034, 3036, 3038, and a future estimate curve 3002 is then fitted to the new points. The relative density of points on the curve in the extreme range (1%, 5%, 10%) ensures that any curve fitting errors are minimised in this area, without having to calculate a relatively large number of points overall in areas that are less significant to the occurrence of future risk.

It will be appreciated that the different aspects of the risk estimation system described above, including but not limited to the parameterised risk, risk models, technical system models, methods for creating or updating risk models, mitigation processes, time series forward estimation, and so on, can be provided in any appropriate combination or subcombination (that is, only some of these aspects may be provided in combination in various alternative embodiments). Essentially the only limitation is what is appropriate and will be expected to function adequately.

It will be appreciated that the present embodiments can be applied to a lot of different types of system and a lot of different types of risk. Suitable subject-matter may include (but is not limited to) robotics and automation, artificial intelligence, 5G technology, block-chain, augmented/virtual reality, autonomous vehicles, drones, medical advances, contagious malware, cloud outage, distributed denial of service, the Internet of Things, industrial control systems, Internet failure, power, transport, telecommunications, satellite systems, water and waste processing, fuel supply, gas supply, industrial accidents (including fire, explosion, pollution, structural failure and nuclear accidents), supply chains, and logistics operations.

The present embodiments can also be applied to natural systems, including causes and effects such as a flood, tropical windstorm, temperate windstorm, drought, freezing temperature, heatwave, wildfire, earthquake, volcanic eruption, tsunami, solar storm, astronomical impact event, climate change, increase in extreme weather, sea level rise, ocean acidification, waste and pollution, ecosystem collapse, deforestation, soil degradation, deficiency of fossil fuels, biogeochemicals, raw materials, water, animal epidemics, plant epidemics, and so on. It will be appreciated that the principles described herein are also applicable to financial, geopolitical, social and governance subject areas as appropriate.

It will be appreciated that further modifications may be made to the invention, where appropriate, within the spirit and scope of the claims.

1. (canceled)

2. (canceled)

3. A computer-implemented method for facilitating estimation of the effect on a technical system of at least one type of risk to the system, each type of risk having a characteristic defined at least partly by a parameter, and the method comprising:
for each type of risk:
selecting a plurality of values of the parameter that defines the characteristic of the type of risk; and
for each of the selected parameter values:
generating an estimate of a numerical effect on at least one state, resource requirement or output of the technical system for the present type of risk having the selected characteristic parameter value;
generating an estimate of a likelihood of occurrence of said numerical effect; and
processing the pairs of estimated numerical effect and estimated likelihood of occurrence to generate a mathematical function having an input corresponding to a parameter of the type of risk and an output corresponding to an estimated numerical effect and a corresponding estimated likelihood of occurrence,
whereby an estimate of the expected numerical effect on at least one state, resource requirement or output of the technical system and an estimate of the likelihood of occurrence of the effect can be provided efficiently for a full range of parameters of all the types of risk.

4. The method according to claim 3, further comprising using the generated mathematical function to estimate the effect on the technical system of at least one said type of risk.

5. The method according to claim 3, further comprising:
receiving at least one input parameter value;
processing said at least one input parameter value in accordance with said mathematical function to generate at least one respective output including an estimate of numerical effect on at least one state, resource requirement or output of the technical system and an estimate of the likelihood of occurrence of the effect; and
in dependence on said at least one output, carrying out at least one of:
(i) modifying a state, property or input of the system, and
(ii) modifying an amount of resources provided to or allocated to the system,
so as to reduce the expected impact on the system of at least one said type of risk.

6. (canceled)

7. The method according to claim 3, wherein at least one said characteristic is selected from: a speed of onset, a degree of severity, and a duration of effect.

8. The method according to claim 3 wherein at least one said characteristic is further defined at least partly by a second parameter, and the method further comprises selecting at least one value of said second parameter, and generating said estimates based on the selected said at least one value of said second parameter.

9. The method according to claim 3, wherein each type of risk has a second characteristic defined at least partly by a further parameter, and the method further comprises selecting at least one value of said further parameter, and generating said estimates based on the selected said at least one value of said further parameter of said second characteristic.

10. The method according to claim 3 further comprising:
defining a target constraint on at least one of a numerical effect on at least one state or output of the technical system and a likelihood of occurrence of the numerical effect; and
processing each mathematical function to determine whether at least one output of the function meets the target constraint for a respective at least one input parameter value of the function;
optionally wherein:
the target constraint is defined in terms of a logarithm or power of the value of at least one of the numerical effect and likelihood of occurrence; and/or
processing each mathematical function comprises determining whether every output of the function, corresponding to every possible input parameter value of the function, meets the target constraint.

11-12. (canceled)

13. The method according to claim 3, further comprising accessing at least one model corresponding to each respective type of risk, each model taking the respective parameter as an input and providing at least one of said numerical effect and said likelihood of occurrence as an output.

14. The method according to claim 13, further comprising receiving data relating to the respective type of risk of at least one said model, processing the received data, and creating or updating the relevant model in dependence on the processing of the received data;
optionally wherein the received data comprises at least one of: time series data representative of a historical or real-time time series that is indicative of the likelihood of occurrence and/or numerical effect of the respective type of risk; performance data indicative of the performance of a relevant part of the technical system; correlation data indicative of a correlation between the respective type of risk and one or more other types of risk; location correlation data indicative of geographical regions of the technical system having a related vulnerability to the respective risk; component correlation data indicative of components of the technical system having an interrelated vulnerability to the respective risk; and free text containing content indicative of a likelihood and/or severity of the respective type of risk.

15. (canceled)

16. The method according to claim 14 wherein the received data comprises time series data representative of a historical or real-time time series that is indicative of the likelihood of occurrence and/or numerical effect of the respective type of risk, and the method further comprises:
processing the received data to identify extreme values of the time series that meet a criterion corresponding to an occurrence of the relevant type of risk; and
processing the extreme values to generate an estimate of the likelihood that a particular proportion of a particular period of time will meet the criterion,
wherein the generated estimate is used at least in part to create or update the model.

17. The method according to claim 16, wherein processing the received data comprises:
dividing the received data into data portions corresponding to a respective plurality of time periods;
processing each data portion to calculate the proportion of the respective time period that meets the criterion; and
processing the calculated proportions to generate an estimation function, the estimation function having as an input a selection of a proportion of a time period, and having an output representing an estimate of the likelihood that the selected proportion of a time period will meet the criterion;
optionally further comprising:
selecting a plurality of sample values of proportions of a period of time;
for each sample value, processing the calculated values to calculate a representative proportion, being a single value representative of substantially all the data portions, of the time period that has values meeting the criterion;
processing the calculated representative proportions to estimate proportions of time for the estimation function at the plurality of sample values; and
generating the estimation function in dependence on the estimated proportions of time.

18. (canceled)

19. The method according to claim 3, further comprising selecting at least one mitigation process from a plurality of possible mitigation processes, and re-generating each function as appropriate in dependence on the selected at least one mitigation process;
optionally wherein at least one said mitigation process is selected in dependence on whether the target constraint is met.

20. (canceled)

21. The method according to claim 19, wherein the mitigation process comprises at least one of: adding, replacing or removing at least one component of the technical system; modifying at least one parameter of the technical system; modifying at least one input to the technical system; modifying the type, source or quantity of at least one resource provided to the technical system; reconfiguring the connection between a plurality of components of the technical system; and modifying the operating procedure relating to at least one component of the technical system.

22. The method according to claim 19, further comprising providing a cost for each possible mitigation process and selecting said at least one mitigation process at least in part in dependence on said cost.

23. The method according to claim 19, further comprising modifying the technical system in accordance with said selected at least one mitigation process and/or modifying at least one said model in accordance with said selected at least one mitigation process.

24. (canceled)

25. The method according to claim 3, wherein a plurality of types of risk is assessed, optionally wherein the estimation of the numerical effect or likelihood of occurrence for one said type of risk is dependent on the numerical effect or likelihood of occurrence for at least one other said type of risk.

26. (canceled)

27. The method according to claim 25 further comprising estimating an additional numerical effect representing additional disruption to the technical system due to a combination of types of risk affecting the technical system.

28. The method according to claim 3, further comprising providing system model data representative of a model of the technical system, and wherein generating at least one said estimate comprises processing the system model data to determine the quantitative effect of the respective type of risk on the technical system;
optionally further comprising receiving scenario data representative of at least one of: at least one risk to apply to the technical system model; at least one configuration of the technical system; at least one setting of the technical system; at least one value of at least one said parameter of a characteristic of at least one said type of risk; and at least one input of the technical system.

29-36. (canceled)

37. Computer program code which, when executed by one or more processors in one or more computer systems, causes said one or more computer systems to carry out the method as defined in claim 3.

38. A computer system including at least one processor and associated memory, the memory containing computer program code as claimed in claim 37.
